(19) United States
(12) Patent Application Publication
(10) Pub. No.: US 2013/0289149 A1
(43) Pub. Date: Oct. 31, 2013

(54) FLEXIBLE POLYURETHANE FOAMS

(71) Applicants: Johan A. Thoen, Antwerpen (BE); Bart Noordover, Eindhoven (NL); Paul Cookson, Samstagern (CH)

(72) Inventors: Johan A. Thoen, Antwerpen (BE); Bart Noordover, Eindhoven (NL); Paul Cookson, Samstagern (CH)

(73) Assignee: DOW GLOBAL TECHNOLOGIES LLC, Midland, MI (US)

(21) Appl. No.: 13/817,495

(22) PCT Filed: Sep. 27, 2011
(86) PCT No.: PCT/US2011/053453

§ 371 Date: Feb. 18, 2013

Related U.S. Application Data
(60) Provisional application No. 61/387,049, filed on Sep. 28, 2010.

(51) Int. Cl. C08G 18/76; C08J 9/00

(52) U.S. Cl. CPC C08G 18/7621; C08J 9/00
USPC 521/124

(57) ABSTRACT

Embodiments of the invention provide for a method of preparing a polyurethane foam, including reacting least one initiator comprising at least two hydroxyl groups with at least one 12-hydroxystearic acid to form at least one polyester polyol, reacting the at least one polyester polyol with at least one alkoxylating agent in the presence of a DMC catalyst to form at least one polyether/polyester polyol, and reacting the at least one polyether/polyester polyol with at least one isocyanate.

### FIELD OF THE INVENTION

Embodiments of the invention relate to polyurethane foams, more specifically to flexible foams made using 12-hydroxystearic acid.

### BACKGROUND OF THE INVENTION

Polyether polyols based on the polymerization of alkylene oxides, polyester polyols, or combinations thereof, are together with isocyanates the major components of a polyurethane system. One class of polyols are conventional petroleum-based polyols, and another class are those polyols made from vegetable oils or other renewable feedstocks (so-called natural oil based polyols, or NOPB). Polyols based on renewable feedstocks may be sold and marketed as a component of polyol blends which often also may include conventional petroleum-based polyols as well as catalysts and other additives. These blends are then reacted with the isocyanates to form foams or other polyurethane products. However, using natural oil based polyols in high concentrations may in certain instances result in a reduced quality of the foam or foaming process. Therefore, there is a need for a method of producing polyurethane foams that result in an increased amount of renewable resources in the final polyurethane product while maintaining the foam's quality.

### SUMMARY OF THE INVENTION

One embodiment of the present invention provides for a method of preparing a polyurethane foam, the method includes reacting least one initiator comprising at least two hydroxyl groups with at least one 12-hydroxystearic acid per equivalent hydroxyl of the initiator to form at least one polyester polyol, reacting the at least one polyester polyol with at least one alkoxylating agent in the presence of a DMC catalyst to form at least one polyether/polyester polyol, and reacting the at least one polyether/polyester polyol with at least one isocyanate.

One embodiment of the present invention provides for a polyurethane foam which includes the reaction product of a reaction system including at least one isocyanate and at least one polyether/polyester polyol. The polyether/polyester polyol includes at least one polyester polyol that has been alkoxylated by an alkoxylating agent in the presence of a DMC catalyst to form the at least one polyether/polyester polyol polyol. The at least one polyester polyol includes the reaction product of at least at least one initiator including at least 2 hydroxyl groups and at least one 12-hydroxystearic acid per equivalent hydroxyl of the initiator.

In one embodiment, the polyurethane foam is a flexible foam, the hydroxyl functionality of the initiator is from about 2 to about 4, the molecular weight of the initiator is from about 50 to about 180, from about 1 to about 2 moles of hydroxystearic acid per equivalent hydroxyl of the initiator is reacted with the initiator, and the polyether/polyester polyol has a number average molecular weight of between about 2500 and about 3500.

In one embodiment, the polyurethane foam is a high resilience flexible foam having a resiliency of at least about 40 percent, the hydroxyl functionality of the initiator is from about 3 to about 6, the molecular weight of the initiator is from about 50 to about 180, from about 1 to about 2 moles of hydroxystearic acid per equivalent hydroxyl of the initiator is reacted with the initiator, and the polyether/polyester polyol has a number average molecular weight of between about 3000 and about 8000.

In one embodiment, the polyurethane foam is a viscoelastic flexible foam having a resiliency of less than about 25 percent, the hydroxyl functionality of the initiator is from about 2 to about 4, the molecular weight of the initiator is from about 50 to about 180, from about 1 to about 4 moles of hydroxystearic acid per equivalent hydroxyl of the initiator is reacted with the initiator, and the polyether/polyester polyol has a number average molecular weight of between about 1800 and about 3000.

In one embodiment, the polyurethane foam is a rigid foam, the hydroxyl functionality of the initiator is from about 3 to about 8, the molecular weight of the initiator is from about 50 to about 180, from about 1 to about 4 moles of hydroxystearic acid per equivalent hydroxyl of the initiator is reacted with the initiator, and the polyether/polyester polyol has a number average molecular weight of between about 1000 and about 4000.

In one embodiment, the polyurethane foam is at least one of coating, adhesive, or sealant, the hydroxyl functionality of the initiator is from about 2 to about 4, the molecular weight of the initiator is from about 50 to about 250, from about 1 to about 2 moles of hydroxystearic acid per equivalent hydroxyl of the initiator is reacted with the initiator, and the polyether/polyester polyol has a number average molecular weight of between about 3000 and about 8000.

In one embodiment, the polyurethane foam is a Reaction Injection Molding polyurethane, the hydroxyl functionality of the initiator is from about 2 to about 4, the molecular weight of the initiator is from about 50 to about 180, from about 1 to about 2 moles of hydroxystearic acid per equivalent hydroxyl of the initiator is reacted with the initiator, and the polyether/polyester polyol has a number average molecular weight of between about 3000 and about 8000.

In one embodiment, the initiator comprises at least one of neopentylglycol, 1,2-propylene glycol, trimethylolpropane, pentaerythritol, sorbitol, sucrose, glycerol, ethanolamine, diethanolamine, and triethanolamine, 1,6-hexanediol, 1,4-butanediol, 1,4-cyclohexane diol, 2,5-hexanediol, ethylene glycol, diethylene glycol, triethylene glycol, bis-3-aminopropyl methylamine, ethylene diamine, diethylene triamine, 9(1)-hydroxymethyloctadecanol, 1,4-bishydroxymethylcyclohexane, 8,8-bis(hydroxymethyl)tricyclo[5,2,1,02,6]decene, hydrogenated bisphenol, 9,9(10,10)-bishydroxymethyloctadecanol, and 1,2,6-hexanetriol.

In one embodiment, the at least one polyester polyol is alkoxylated by an alkoxylating agent which is first propylene oxide followed by a mixture of ethylene oxide and propylene oxide.

In one embodiment, the at least one polyether/polyester polyol comprises 100% of the polyols used.

In one embodiment, the at least one isocyanate is also reacted with at least one conventional petroleum-based polyol.

### DESCRIPTION OF EMBODIMENTS OF THE INVENTION

The embodiments of the present invention satisfy the needs for producing polyurethane foams that result in an increased amount of renewable resources in the final polyurethane product while also keeping desired properties of the polyurethane product. For example, described herein, according to embodiments of the invention, are polyurethane foams that have a high concentration of renewable resources while retaining favorable cell structures, airflow, tensile strength, elongation, ball rebound, SAG factor, and compression set.

The polyurethane foams may be formed by reacting at least one isocyanate and at least one polyether/polyester polyol. The polyether/polyester polyol may in one embodiment be made by first reacting 12-hydroxystearic acid (12-HSA), or the methyl ester of 12-HSA, with an initiator. 12-HSA is commercially available from, for example Jayant Oils and Derivatives Ltd, or may be obtained through the hydrogenation of castor oil, followed by the hydrolysis of the obtained saturated triglyceride. Subsequently, Me-12-HSA can be obtained by reacting 12-HSA with methanol. Alternatively, hydrogenated castor oil can be transesterified with methanol directly.

A polyester polyol is formed by reacting the 12-HSA and/or Me-12-HSA with an appropriate initiator compound. The initiator may be any initiator used in the production of conventional petroleum-based polyols, such as neopentylglycol; 1,2-propylene glycol; trimethylolpropane; pentaerythritol; sorbitol; sucrose; glycerol; aminoalcohols such as ethanolamine, diethanolamine, and triethanolamine; alkanediols such as 1,6-hexanediol, 1,4-butanediol; 1,4-cyclohexane diol; 2,5-hexanediol; ethylene glycol; diethylene glycol, triethylene glycol; bis-3-aminopropyl methylamine; ethylene diamine; diethylene triamine; 9(1)-hydroxymethyloctadecanol, 1,4-bishydroxymethylcyclohexane; 8,8-bis(hydroxymethyl)tricyclo[5,2,1,02,6]decene; Dimerol alcohol (36 carbon diol available from Henkel Corporation); hydrogenated bisphenol; 9,9(10,10)-bishydroxymethyloctadecanol; 1,2,6-hexanetriol and combination thereof. In one embodiment, the initiator is a mixture of 1,3-cyclohexanedimethanol and 1,4-cyclohexanedimethanol and is commercially available under the trade name UNOXOL from The Dow Chemical Company which is an approximate 1:1 mixture of (cis, trans) 1,3-cyclohexanedimethanol and (cis, trans) 1,4-cyclohexanedimethanol.

The reaction of 12-HSA and/or Me-12-HSA with the initiator compound may be performed using the conditions as described in, for example, PCT publication No. WO 2004/096882.

The total amount of 12-HSA and/or Me-12-HSA that is used may depend on the desired equivalent weight of the polyester polyol. As few as 1 mole of 12-HSA and/or Me-12-HSA per equivalent hydroxyl of the initiator may be added. The embodiments of the invention are well suited for adding of at least about 1 mole of 12-HSA and/or Me-12-HSA per equivalent hydroxyl-group of initiator. As many as 6 moles or more of 12-HSA and/or Me-12-HSA per equivalent hydroxyl of the initiator may be added. Sufficient 12-HSA and/or Me-12-HSA can be added to make any desirable molecular weight polyester polyol, such as one having a number average molecular weight of between about 200 and about 2400.

The functionality of the resulting polyester polyol is above about 1.5 and generally not higher than about 8. In one embodiment, the functionality is below about 4. The hydroxyl number of the of the polyester polyols may be below about 300 mg KOH/g, preferably between about 50 and about 300, preferably between about 60 and about 200. In one embodiment, the hydroxyl number is below about 100.

In one embodiment, where a slabstock flexible foam is desired, the functionality of the initiator may be from about 2 to about 4 and the molecular weight of the initiator may be from about 50 to about 180. From about 1 to 2 moles of 12-HSA and/or Me-12-HSA per equivalent hydroxyl of the initiator may be added, so that the polyester polyol has a number average molecular weight of between about 618 and about 1570.

In one embodiment, where a high resilience flexible foam is desired, the functionality of the initiator may be from about 3 to about 6 and the molecular weight of the initiator may be from about 50 to about 180. From about 1 to 2 moles of 12-HSA and/or Me-12-HSA per equivalent hydroxyl of the initiator may be added, so that the polyester polyol has a number average molecular weight of between about 900 and about 2400. The term “resilience” or “resiliency” is used to refer to the quality of a foam perceived as springiness. It is measured according to the procedures of ASTM D3574 Test H. This ball rebound test measures the height a dropped steel ball of known weight rebounds from the surface of the foam when dropped under specified conditions and expresses the result as a percentage of the original drop height. As measured according to the ASTM test, a high resilience (HR) foam exhibits a resiliency of at least about 40 percent, more preferably at least about 42 percent, most preferably at least about 48 percent and advantageously at least about 50 percent.

In one embodiment, where a viscoelastic flexible foam is desired, the functionality of the initiator may be from about 2 to about 4 and the molecular weight of the initiator may be from about 50 to about 180. From about 1 to about 4 moles of 12-HSA and/or Me-12-HSA per equivalent hydroxyl of the initiator may be added, so that the polyester polyol has a number average molecular weight of between about 618 and about 1600. As used herein, term “viscoelastic foam” is intended to designate those foams having a resilience of less than 25%, as measured according to ASTM D3574 Test H. Preferably the foam will have a resilience of less than 20%. If further embodiments the foam will have a resilience of less than 15% or even less than 10%. In certain embodiments the foams have a resiliency of 5% or less and even less than 3%. As used herein, the term “viscoelasticity” is the time dependent response of a material to an applied constant load (stress) due to the co-existence of elastic (solid) and viscous (liquid) characteristics in the material. In dynamic mechanical characterization, the level of viscoelasticity is proportional to the damping coefficient measured by the tan delta of the material. The tan delta is the ratio of the viscous dissipative loss modulus E″ to the Young's elastic modulus E′. High tan delta values imply that there is a high viscous component in the material behavior and hence a strong damping to any perturbation will be observed. E′ and tan delta are determined dynamic mechanical thermal analysis (DMTA). DMTA herein is measured using a TA Instruments RSA III Rheometer with the cylindrical tension/compression geometry fixture. The test type is a Dynamic Temperature Ramp method with an initial temperature of −115.0° C. and a final temperature of 250.0° C. at a ramp rate of 3.0° C./min The E′ to 25% CFD's are normalized to densities.

In one embodiment, where a rigid foam is desired, the functionality of the initiator may be from about 3 to about 8 and the molecular weight of the initiator may be from about 50 to about 350. From about 1 to about 4 moles of 12-HSA and/or Me-12-HSA per equivalent hydroxyl of the initiator may be added, so that the polyester polyol has a number average molecular weight of between about 900 and about 3460.

In one embodiment, where a coating, adhesive, or sealant is desired, the functionality of the initiator may be from about 2 to about 4 and the molecular weight of the initiator may be from about 50 to about 250. From about 1 to about 2 moles of 12-HSA and/or Me-12-HSA per equivalent hydroxyl of the initiator may be added, so that the polyester polyol has a number average molecular weight of between about 618 and about 2400.

In one embodiment, where a RIM (Reaction Injection Molding) polyurethane is desired, the functionality of the initiator may be from about 2 to about 4 and the molecular weight of the initiator may be from about 50 to about 180. From about 1 to about 2 moles of 12-HSA and/or Me-12-HSA per equivalent hydroxyl of the initiator may be added, so that the polyester polyol has a number average molecular weight of between about 618 and about 2400.

The polyester polyol may then be alkoxylated in the presence of at least one double metal cyanide (DMC) catalyst to form a polyether/polyester polyol. The alkoxylation may be performed by first mixing the polyester polyol and catalyst. The dispersion of solid catalyst may be homogenized with a commercially available homogenizer, such as an IKA Ultra Turrax T25. The catalyst may alternatively be dispersed in a solvent and then mixed with the polyester polyol. The solvent may be a non-protic polar solvent such as acetone, DMSO or THF. Alternatively the solvent may be a non-protic non-polar solvent such as benzene, toluene or xylene. An acid, such as phosphoric acid, may also be added to the DMC catalyst and polyester polyol mixture. Stirring may be performed at between about 10 rpm and about 30000 rpm, such as at about 20000 rpm. While stirring, the mixture may heated to between about 90° C. and about 160° C., such as between about 110° C. and about 140° C., and may be flushed several times with an inert gas, such as nitrogen or argon. While continuing to stir the mixture, a vacuum may be applied to reduce the pressure in the reaction vessel to about 0.01-0.9 bar, such as about 0.02-0.5 bar.

The mixture of catalyst and polyester polyol are then heated to between about 90° C. and about 160° C., such as between about 110° C. and about 140° C., and then the reactor is pressurized with an initial quantity of alkylene oxide, until a pressure is reached in the reaction vessel of between about 1 bar and about 10 bar, preferably between about 2 bar and about 5 bar. In one embodiment, the mixture is heated to about 130 ° C., and the reaction vessel pressurized with alkylene oxide to about 3 bars. The reaction may progress at a slow reaction rate for about 0-30 hours, as indicated by a slowly decreasing pressure in the reactor

Depending on the desired degree of alkoxylation, all the necessary alkylene oxide may be added to the reactor at the outset. However, it is also possible to add more alkylene oxide to the reactor once the reaction rate increases as the reaction proceeds. Alternatively, any additional alkylene oxide may be fed in one or more discrete increments. In one embodiment, the reaction vessel is maintained at about 130° C. and alkylene oxide is fed to the reaction vessel over a period of between about ½ hour and about 1.5 hours at a feed rate of between about 300 g/hour and about 900 g/hour.

The total amount of alkylene oxide that is fed may depend on the desired equivalent weight of the product. As few as one mole of alkylene oxide per equivalent hydroxyl of the polyester polyol may be added. The embodiments of the invention are well suited for adding of at least about 1 mole of alkylene oxide per equivalent hydroxyl-group of polyester polyol. Sufficient alkylene oxide can be added to make any desirable molecular weight polyether, such as one having a weight average molecular weight of 200,000 daltons or more. However, in most cases the intended end-use of the product will dictate its molecular or equivalent weight. Thus, for example, for making polyols for polyurethane applications, polyether equivalent weights of from about 75-300 are of particular interest for rigid polyurethane foams, equivalent weights of from about 300-1300 are of particular interest for making molded foams and high resilience slabstock foams, and equivalent weights of from about 800-3000 are of particular interest for making conventional slabstock foam and reaction injection molded elastomers. For surfactant applications, molecular weights of from about 350 to about 6000 are of particular interest. In most applications, it is desirable that the product be a liquid. All weights reported above are number average molecular weights.

Similarly, the selection of alkylene oxide will depend to a large extent on the intended end-use of the product. Among the alkylene oxides that can be polymerized with the catalyst complex of the invention are ethylene oxide, propylene oxide, 1,2-butylene oxide, styrene oxide, and epichlorohydrin. Mixtures of these can be used, and two or more of them can be polymerized sequentially to make block copolymers. For polyurethanes applications, preferred alkylene oxides are propylene oxide alone, mixtures of at least 50 weight % propylene oxide and up to about 50 weight % ethylene oxide (to form a random copolymer), and propylene oxide followed by ethylene oxide, so as to form terminal poly(oxyethylene) chains constituting up to about 30% of the total weight of the product. For other applications, ethylene oxide alone, 1,2-butylene oxide, ethylene oxide/1,2-butylene oxide mixtures, ethylene oxide followed by propylene oxide or butylene oxide, butylene oxide followed by ethylene and/or propylene oxide, propylene oxide alone, mixtures of propylene oxide and ethylene and/or butylene oxide, propylene oxide followed by ethylene and propylene oxide, and propylene oxide followed by ethylene and/or butylene oxide are preferred alkylene oxides. In one embodiment, propylene oxide is first used in a one batch fashion, followed by the addition of a mixture of ethylene oxide and propylene oxide at of 20/80 wt/wt ratios (25/75 mole/mole ratios) a rate of about 900 g/hr.

In the various embodiments of the invention, the concentration of the catalyst may be selected to polymerize the alkylene oxide at a desired rate or within a desired period of time. Generally, a suitable amount of catalyst is from about 5 to about 10,000 parts by weight metal cyanide catalyst complex per million parts of the product. For determining the amount of catalyst complex to use, the weight of the product is generally considered to equal the combined weight of alkylene oxide and modified oils, plus any comonomers that may be used. More preferred catalyst complex levels are from about 10 to about 10000, especially from about 25, to about 1000. In one embodiment, the amount of catalyst is about 50 ppm.

In some embodiments, a DMC compound may comprise a reaction product of a water-soluble metal salt and a water-soluble metal cyanide salt. A water-soluble metal salt may have the general formula M(X)n in which M is a metal and X is an anion. M may be selected from Zn(II), Fe(II), Ni(II), Mn(II), Co(II), Sn(II), Pb(II), Fe(III), Mo(IV), Mo(VI), Al(III), V(V), V(IV), Sr(II), W(IV), W(VI), Cu(II), and Cr(III). It may be desirable in some embodiments for M to be selected from Zn(II), Fe(II), Co(II), and Ni(II). X may be an anion selected from a halide, a hydroxide, a sulfate, a carbonate, a cyanide, and oxylate, a thiocyanate, an isocyanate, an isothiocyanate, a carboxylate, and a nitrate. The value of n may be from 1 to 3 and satisfy the valency state of M. Examples of a suitable metal salt may include, without limitation, zinc chloride, zinc bromide, zinc acetate, zinc acetonylacetonate, zinc benzoate, zinc nitrate, iron(II) sulfate, iron(II) bromide, cobalt(II) chloride, cobalt(II) thiocyanate, nickel(II) formate, nickel(II) nitrate, and the like, and mixtures thereof.

A water-soluble metal cyanide salt may have the general formula (Y)aM′(CN)b(A)c. in which M′ may be selected from Fe(II), Fe(III), Co(II), Co(III), Cr(II), Cr(III), Mn(II), Mn(III), Ir(III), Ni(II), Rh(III), Ru(II), V(IV), V(V), and combinations thereof It may be desirable in some embodiments for M′ to be selected from Co(II), Co(III), Fe(II), Fe(III), Cr(III), Ir(III), Ni(II), and combinations thereof. In the formula, Y may be an alkali metal ion or alkaline earth metal ion. A may be an ion selected from the group consisting of halide, hydroxide, sulfate, carbonate, cyanide, oxalate, thiocyanate, isocyanate, isothiocyanate, carboxylate, and nitrate. Both a and b are integers equal to or greater than 1. In addition, the sum of the charges of a, b, and c balances the charge of M′. Examples of a suitable metal cyanide salt may include, without limitation, potassium hexacyanocobaltate(III), potassium hexacyanoferrate(II), potassium hexacyanoferrate(III), calcium hexacyanocobaltate(III), lithium hexacyanocobaltate(III), and the like.

Examples of a double metal cyanide compound may include, without limitation, zinc hexacyanocobaltate(III), zinc hexacyanoferrate(III), nickel hexacyanoferrate(II), and/or cobalt hexacyanocobaltate(III). In some embodiments, it may be desirable to use zinc hexacyanocobaltate(III).

A solid DMC catalyst, according to some embodiments, may include an organic complexing agent. Generally, it may be desirable (e.g., necessary) for a complexing agent to be relatively soluble in water. Examples of some suitable complexing agents are elaborated in U.S. Pat. No. 5,158,922. A complexing agent may be added during preparation and/or immediately following precipitation of the catalyst. An excess amount of the complexing agent may be used. A complexing agent may comprise a water-soluble heteroatomcontaining organic compound that may complex with a double metal cyanide compound. For example, complexing agents may include alcohols, aldehydes, ketones, ethers, esters, amides, ureas, nitriles, sulfides, and mixtures thereof Specific example embodiments of a complexing agent may include, without limitation, a water-soluble aliphatic alcohol selected from ethanol, isopropyl alcohol, n-butyl alcohol, isobutyl alcohol, sec-butyl alcohol, and tertbutyl alcohol. In some embodiments, it may be desirable to use a complexing agent comprising tert-butyl alcohol.

In some embodiments, a solid DMC catalyst may include from about 5 to about 80 wt. %, based on amount of catalyst, of a polyether. For example, it may be desirable to include from about 10 to about 70 wt. % of the polyether. It may be desirable to include from about 15 to about 60 wt. % of the polyether.

The functionality of the resulting polyether/polyester polyol is above about 1.5 and generally not higher than about 8. In one embodiment, the functionality is below about 4. The hydroxyl number of the of the natural oil based polyols may be below about 300 mg KOH/g, preferably between about 50 and about 300, preferably between about 60 and about 200. In one embodiment, the hydroxyl number is below about 100.

In one embodiment, where a slabstock flexible foam is desired, polyether/polyester polyol has a number average molecular weight of between about 2500 and about 3500.

In one embodiment, where a high resilience flexible foam is desired, the polyether/polyester polyol has a number average molecular weight of between about 3000 and about 8000.

In one embodiment, where a viscoelastic flexible foam is desired, the polyether/polyester polyol has a number average molecular weight of between about 1800 and about 3000.

In one embodiment, where a rigid foam is desired, the polyether/polyester polyol has a number average molecular weight of between about 1000 and about 4000.

In one embodiment, where a coating, adhesive, or sealant is desired, the polyether/polyester polyol has a number average molecular weight of between about 3000 and about 8000.

In one embodiment, where a RIM (Reaction Injection Molding) polyurethane is desired, the polyether/polyester polyol has a number average molecular weight of between about 3000 and about 8000.

The polyether/polyester polyols described herein may have renewable carbon contents above about 10% based on the total carbon content of polyether/polyester polyols. The renewable carbon content may be above about 10%, 15%, 20%, 25%, 30%, 35%, 40%, 45%, 50%, 55%, 60, 65, 70, 75, 80, 85% or 90%. The renewable carbon contents of the polyether/polyester polyols may be calculated and/or measured as described in PU Magazine, Vol. 5, No. 6, December 2008, pages 368-372.

A surprising advantage of the polyether/polyester polyols of the various embodiments described herein, is that the polyether/polyester polyols may be used in a neat fashion in polyurethane production systems. That is, the polyether/polyester polyols may constitute up to 100% of the polyols used in the systems. In other embodiments the polyether/polyester polyols may constitute up to about 30, 35, 40, 45, 50, 60, 70, 80, 90, 95, 96, 97, 98, or 99 weight % of the polyols used in the systems. The polyether/polyester polyols may constitute at least about 10, 20, 30, 40, 50, 55, 60, 65, 70, 75, 80, or 90 weight % of the polyols used in the systems.

However, it is also possible to use the polyether/polyester polyols as a component in a polyol blend. Additionally, the polyol blend may include at least one conventional petroleum-based polyol. The at least one conventional petroleum-based polyol includes materials having at least one group containing an active hydrogen atom capable of undergoing reaction with an isocyanate, and not having parts of the material derived from a vegetable or animal oil. Suitable conventional petroleum-based polyols are well known in the art and include those described herein and any other commercially available polyol. Mixtures of one or more polyols and/or one or more polymer polyols may also be used to produce polyurethane products according to embodiments of the present invention.

Representative polyols include polyether polyols, polyester polyols, polyhydroxy-terminated acetal resins, hydroxyl-terminated amines and polyamines. Alternative polyols that may be used include polyalkylene carbonate-based polyols and polyphosphate-based polyols. Preferred are polyols prepared by adding an alkylene oxide, such as ethylene oxide, propylene oxide, butylene oxide or a combination thereof, to an initiator having from 2 to 8, preferably 2 to 6 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound. The initiators suitable for the natural oil based polyols may also be suitable for the at least one conventional petroleum-based polyol.

The at least one conventional petroleum-based polyol may for example be poly(propylene oxide) homopolymers, random copolymers of propylene oxide and ethylene oxide in which the poly(ethylene oxide) content is, for example, from about 1 to about 30% by weight, ethylene oxide-capped poly(propylene oxide) polymers and ethylene oxide-capped random copolymers of propylene oxide and ethylene oxide. For slabstock foam applications, such polyethers preferably contain 2-5, especially 2-4, and preferably from 2-3, mainly secondary hydroxyl groups per molecule and have an equivalent weight per hydroxyl group of from about 400 to about 3000, especially from about 800 to about 1750. For high resilience slabstock and molded foam applications, such polyethers preferably contain 2-6, especially 2-4, mainly primary hydroxyl groups per molecule and have an equivalent weight per hydroxyl group of from about 1000 to about 3000, especially from about 1200 to about 2000. When blends of polyols are used, the nominal average functionality (number of hydroxyl groups per molecule) will be preferably in the ranges specified above. For viscoelastic foams shorter chain polyols with hydroxyl numbers above 150 are also used. For the production of semi-rigid foams, it is preferred to use a trifunctional polyol with a hydroxyl number of 30 to 80.

The polyether polyols may contain low terminal unsaturation (for example, less that 0.02 meq/g or less than 0.01 meq/g), such as those made using a DMC catalysts. Polyester polyols typically contain about 2 hydroxyl groups per molecule and have an equivalent weight per hydroxyl group of about 400-1500.

The conventional petroleum-based polyols may be a polymer polyol. In a polymer polyol, polymer particles are dispersed in the conventional petroleum-based polyol. Such particles are widely known in the art an include styrene-acrylonitrile (SAN), acrylonitrile (ACN), polystyrene (PS), methacrylonitrile (MAN), polyurea (PHD), or methyl methacrylate (MMA) particles. In one embodiment the polymer particles are SAN particles.

The conventional petroleum-based polyols may constitute up to about 10 weight %, 20 weight %, 30 weight %, 40 weight %, 50 weight %, 60 weight %, 70 weight %, or 80 weight % of the polyol blend. The conventional petroleum-based polyols may constitute at least about 1 weight %, 5 weight %, 10 weight %, 20 weight %, 30 weight %, 40 weight %, or 50 weight % of polyol formulation.

In addition to the above described polyols, the polyol blend may also include other ingredients such as catalysts, silicone surfactants, preservatives, and antioxidants,

The polyol blend may be used in the production of polyurethane products, such as polyurethane foams, elastomers, microcellular foams, adhesives, coatings, etc. For example, the polyol blend may be used in a formulation for the production of flexible or rigid polyurethane foam. For the production of a polyurethane foam the polyol blend may be combined with additional ingredients such as catalysts, crosslinkers, emulsifiers, silicone surfactants, preservatives, flame retardants, colorants, antioxidants, reinforcing agents, fillers, including recycled polyurethane foam in form of powder.

Any suitable urethane catalyst may be used, including tertiary amine compounds, amines with isocyanate reactive groups and organometallic compounds. Exemplary tertiary amine compounds include triethylenediamine, N-methylmorpholine, N,N-dimethylcyclohexylamine, pentamethyldiethylenetriamine, tetramethyl-iethylenediamine, bis(dimethylaminoethyl)ether, 1-methyl-4-dimethylaminoethyl-piperazine, 3-methoxy-N-dimethylpropylamine, N-ethylmorpholine, dimethylethanolamine, N-cocomorpholine, N,N-dimethyl-N′,N′-dimethyl isopropylpropylenediamine, N,N-diethyl-3-diethylamino-propylamine and dimethylbenzylamine. Exemplary organometallic catalysts include organomercury, organolead, organoferric and organotin catalysts, with organotin catalysts being preferred among these. Suitable tin catalysts include stannous chloride, tin salts of carboxylic acids such as dibutyltin di-laurate. A catalyst for the trimerization of isocyanates, resulting in a isocyanurate, such as an alkali metal alkoxide may also optionally be employed herein. The amount of amine catalysts can vary from 0 to about 5 percent in the formulation or organometallic catalysts from about 0.001 to about 1 percent in the formulation can be used.

One or more crosslinkers may be provided, in addition to the polyols described above. This is particularly the case when making high resilience slabstock or molded foam. If used, suitable amounts of crosslinkers are from about 0.1 to about 1 part by weight, especially from about 0.25 to about 0.5 part by weight, per 100 parts by weight of polyols.

The crosslinkers may have three or more isocyanate-reactive groups per molecule and an equivalent weight per isocyanate-reactive group of less than 400. The crosslinkers preferably may include from 3-8, especially from 3-4 hydroxyl, primary amine or secondary amine groups per molecule and have an equivalent weight of from 30 to about 200, especially from 50-125. Examples of suitable crosslinkers include diethanol amine, monoethanol amine, triethanol amine, mono- di- or tri(isopropanol) amine, glycerine, trimethylol propane, pentaerythritol, and sorbitol.

It is also possible to use one or more chain extenders in the foam formulation. The chain extender may have two isocyanate-reactive groups per molecule and an equivalent weight per isocyanate-reactive group of less than 400, especially from 31-125. The isocyanate reactive groups are preferably hydroxyl, primary aliphatic or aromatic amine or secondary aliphatic or aromatic amine groups. Representative chain extenders include amines ethylene glycol, diethylene glycol, 1,2-propylene glycol, dipropylene glycol, tripropylene glycol, ethylene diamine, phenylene diamine, bis(3-chloro-4-aminophenyl)methane and 2,4-diamino-3,5-diethyl toluene. If used, chain extenders are typically present in an amount from about 1 to about 50, especially about 3 to about 25 parts by weight per 100 parts by weight high equivalent weight polyol.

A polyether polyol may also be included in the formulation, i.e, as part of the at least one conventional petroleum-based polyol, to promote the formation of an open-celled or softened polyurethane foam. Such cell openers generally have a functionality of 2 to 12, preferably 3 to 8, and a molecular weight of at least 5,000 up to about 100,000. Such polyether polyols contains at least 50 weight percent oxyethylene units, and sufficient oxypropylene units to render it compatible with the components. The cell openers, when used, are generally present in an amount from 0.2 to 5, preferably from 0.2 to 3 parts by weight of the total polyol. Examples of commercially available cell openers are VORANOL Polyol CP 1421 and VORANOL Polyol 4053; VORANOL is a trademark of The Dow Chemical Company.

The formulations may then be reacted with, at least one isocyanate to form a flexible polyurethane foam. Isocyanates which may be used in the present invention include aliphatic, cycloaliphatic, arylaliphatic and aromatic isocyanates.

Examples of suitable aromatic isocyanates include the 4,4′-, 2,4′ and 2,2′-isomers of diphenylmethane diisocyante (MDI), blends thereof and polymeric and monomeric MDI blends, toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimehtyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Mixtures of isocyanates may be used, such as the commercially available mixtures of 2,4- and 2,6-isomers of toluene diisocyantes. A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends may also be used.

Examples of aliphatic polyisocyanates include ethylene diisocyanate, 1,6-hexamethylene diisocyanate, isophorone diisocyanate, cyclohexane 1,4-diisocyanate, 4,4′-dicyclohexylmethane diisocyanate, 1,3-bis(isocyanatomethyl)cyclohexane, 1,4-bis(isocyanatomethyl)cyclohexane, saturated analogues of the above mentioned aromatic isocyanates, and mixtures thereof.

The at least one isocyanate is added to the blend for an isocyanate index of between about 30 and about 150, preferably between about 50 and about 120, more preferably between about 60 and about 110. The isocyanate index is the ratio of isocyanate-groups over isocyanate-reactive hydrogen atoms present in a formulation, given as a percentage. Thus, the isocyanate index expresses the percentage of isocyanate actually used in a formulation with respect to the amount of isocyanate theoretically required for reacting with the amount of isocyanate-reactive hydrogen used in a formulation.

For the production of flexible foams, the polyisocyanates may often be the toluene-2,4- and 2,6-diisocyanates or MDI or combinations of TDI/MDI or prepolymers made therefrom.

Isocyanate tipped prepolymer may also be used in the polyurethane formulation. Such prepolymers are obtained by the reaction of an excess of polyol. The polyol may be the conventional petroleum-based polyol or the polyether/polyester polyol and/or a combination of the polyols.

Processing for producing polyurethane products are well known in the art. In general components of the polyurethane-forming reaction mixture may be mixed together in any convenient manner, for example by using any of the mixing equipment described in the prior art for the purpose such as described in “Polyurethane Handbook”, by G. Oertel, Hanser publisher.

In general, the polyurethane foam is prepared by mixing the polyisocyanate of and polyol composition in the presence of the blowing agent, catalyst(s) and other optional ingredients as desired under conditions such that the polyisocyanate and polyol blend react to form a polyurethane and/or polyurea polymer while the blowing agent generates a gas that expands the reacting mixture. The foam may be formed by the so-called prepolymer method, in which a stoichiometric excess of the polyisocyanate is first reacted with the high equivalent weight polyol(s) to form a prepolymer, which is in a second step reacted with a chain extender and/or water to form the desired foam. Frothing methods are also suitable. So-called one-shot methods may be preferred. In such one-shot methods, the polyisocyanate and all polyisocyanate-reactive are simultaneously brought together and caused to react. Three widely used one-shot methods which are suitable for use in this invention include slabstock foam processes, high resilience slabstock foam processes, and molded foam methods.

Slabstock foam is conveniently prepared by mixing the foam ingredients and dispensing them into a trough or other region where the reaction mixture reacts, rises freely against the atmosphere (sometimes under a film or other flexible covering) and cures. In common commercial scale slabstock foam production, the foam ingredients (or various mixtures thereof) are pumped independently to a mixing head where they are mixed and dispensed onto a conveyor that is lined with paper or plastic. Foaming and curing occurs on the conveyor to form a foam bun. The resulting foams are typically from about from about 10 kg/m3 to 100 kg/m3, especially from about 15 kg/m3 to 90 kg/m3, preferably from about 17 kg/m3 to 80 kg/m3 in density.

A preferred slabstock foam formulation contains from about 1 to about 6, preferably about 1.5 to about 5 parts by weight water are used per 100 parts by weight high equivalent weight polyol at atmospheric pressure. At reduced pressure these levels are reduced.

In the production of rigid polyurethane foams, the blowing agent includes water, and mixtures of water with a hydrocarbon, or a fully or partially halogenated aliphatic hydrocarbon. The amount of water is may be in the range between about 2 and about 15 parts by weight, preferably between about 2 and about 10 parts by weight based on 100 parts of the polyol. The amount of hydrocarbon, the hydrochlorofluorocarbon, or the hydrofluorocarbon to be combined with the water is suitably selected depending on the desired density of the foam, and may be less than about 40 parts by weight, preferably less than about 30 parts by weight based on 100 parts by weight of the polyol. When water is present as an additional blowing agent, it is may be present in an amount between about 0.5 and 10, preferably between about 0.8 and about 6, preferably between about 1 and about 4, and preferably between about 1 and about 3 parts by total weight of the total polyol composition.

Molded foam can be made according to the invention by transferring the reactants (polyol composition including copolyester, polyisocyanate, blowing agent, and surfactant) to a closed mold where the foaming reaction takes place to produce a shaped foam. Either a so-called “cold-molding” process, in which the mold is not preheated significantly above ambient temperatures, or a “hot-molding” process, in which the mold is heated to drive the cure, can be used. Cold-molding processes are preferred to produce high resilience molded foam. Densities for molded foams generally range from 30 to 80 kg/m3.

The polyurethanes made using the polyether/polyester polyols described herein may have renewable carbon contents above about 10% based on the total carbon content of the foams. The renewable carbon content may be above about 5, 10%, 15%, 20%, 25%, 30%, 35%, 40%, 45%, 50%, 55%, 60%, 65, or 70%. The renewable carbon contents of the polyurethanes may be calculated and/or measured as described in PU Magazine, Vol. 5, No. 6, December 2008, pages 368-372.

### EXAMPLES

The following examples are provided to illustrate the embodiments of the invention, but are not intended to limit the scope thereof. All parts and percentages are by weight unless otherwise indicated.

The following materials were used:

| | |
|---|---|
| Me-12-HAS | 12-hydroxystearic acid available from Jayant Oils |
| | and Derivatives Ltd. |
| Pentaerythritol | Available from Sigma-Aldrich Co. |
| Nonane | Available from Sigma-Aldrich Co. |
| DABCO T9 | A stannous octoate catalyst available from Air |
| | Products & Chemicals Inc. |
| Magnesium silicate | Available from Magnesium silicate. |
| DMC P5 catalyst | A DMC catalyst available CAC Shanghai |
| Phosphoric acid | 85 wt % solution in water. Available from Sigma- |
| | Aldrich Co. |
| Propylene oxide | Available from The Dow Chemical Company. |
| Ethylene oxide | Available from The Dow Chemical Company. |
| VORANOL* 3008 | An all propylene oxide triol with an OH number of |
| | 56 available from The Dow Chemical company |
| VORANOL* | A polyoxypropylene polyoxyethylene triol with an |
| CP 3322 | OH number of 48 available from The Dow Chemical |
| | Company. |
| TEGOSTAB | A Polysiloxane polyoxyalkylene block copolymer |
| BF-2370 | for flexible polyurethane slabstock and molded foams. |
| | available from Evonik Industries. |
| NIAX A-1 | A tertiary amine catalyst available from Momentive |
| | Performance Materials. |
| DABCO 33-LV | A 33% solution of triethylenediamine in propylene |
| | glycol available from Air Products & Chemicals Inc. |
| VORANATE* | A toluene diisocyanate (80% 2,4-toluene diisocyanate |
| T-80 | and 20% 2,6-toluene diisocyanate by weight) compo- |
| | sition available from The Dow Chemical Company. |

*VORANATE and VORANOL are trademarks of The Dow Chemical Company.

Step 1: Transesterification of the methyl ester of 12-hydroxystearic acid (Me-12-HSA) with pentaerythritol (PE)

Me-12-HSA (1297.2 g, 412 moles) was charged into a glass reactor fitted with a mechanical stirrer, thermocouples, a nitrogen sparge, and a Dean-Stark set-up to collect the condensation product. Pentaerythritol (151.6 g, 1.11 moles) was added as a solid. Entrainer (nonane, 220 g) and catalyst (DABCO T9, 17.14 g) were added and the reaction temperature was increased stepwise up to 200° C. to maintain entrainer reflux and distillation of the condensate while stirring at 600 rpm. A methanol phase separated from the entrainer in the Dean-Stark trap and was collected to monitor conversion. Subsequently, vacuum processing was performed at a final pressure of approximately 1 mbar, the set-up was left under vacuum at 200° C. for 2 hours. The product was then left to cool down to 120° C. and of magnesium silicate (75 g) was stirred into the mixture for 1 hour to facilitate catalyst removal. The reaction mixture was filtered over a magnesium silicate cake, bottled and left to cool down and solidify. Yield: 88%; entrainer recovery: 95%. OHV: 167 mgKOH/g.

Step 2: Alkoxylation of the PE/Me-12-HSA Tetra-Ester with EO/PO Mixed Feed

DMC P5 catalyst (0.132 g, 100 ppm in final batch quantity) was dispersed into the PE/Me-12-HSA tetra-ester obtained in Step 1 (401.3 g, 0.30 mole) using an ultraturrax mixer operated at approx. 20,000 rpm. The DMC P5 Catalyst/PE/Me-12-HSA tetra-ester dispersion was fed to a reactor and phosphoric acid (0.024 g, 85 wt % solution) was added. The reactor was flushed repeatedly with nitrogen and flashed in vacuo for 30 minutes at 130° C., after which a vacuum was maintained at a pressure of about 0.05 bar. Then, propylene oxide (74 g, 0.86 mole) was added, leading to a reactor pressure of 3.0 bars. Activation occurred after 20 minutes at 130° C., and was observed as a rapid decrease in reactor pressure (down to 0.15 bar) in combination with an exotherm (temperature increase of approx. 17° C.). Subsequently, a mixture of ethylene oxide and propylene oxide (20/80 wt/wt, 25/75 mole/mole, 891 g) was fed to the reactor at 900 g/hr. Upon feed completion, the reaction mixture was flashed to remove residual EO and PO, and cooled down to 85 ° C. before discharge. The exact amount and ratio of oxides fed were determined by a mass balance and NMR spectroscopy, respectively. Yield 99%. OHV: 52.2 mgKOH/g.

### BOX FOAMS, EXAMPLE E1 AND COMPARATIVE EXAMPLES C1 AND C2

Polyol, TEGOSTAB BF-2370, NIAX A-1, and DABCO 33-LV were weighed into a 1 liter plastic beaker. After checking the mixer speed was set at 2500 rpm the following mixing procedure was then used:
Start the stopwatch and rise profile (foam height) software
At 5 s, start mixing the polyol blend
At 20 s, add the gelation catalyst (Stannous octoate, DABCO T9)
At 30 s, add the isocyanate (this is taken as t₀ i.e. the time when reaction starts)
At 40 s, stop the mixer and pour the mixture into a cardboard mould.

Rise profiles were measured during foaming of the different polyols and the full rise and blow off times were recorded. The foams were then transferred to an oven set at 140° C. for 10 minutes and then allowed to cure for a further 24 hours at room temperature before cutting for physical property testing. Foam physical properties were then tested according to the listed standards, see Table 1.

TABLE 1

| | | C1 | C2 | E1 |
|---|---|---|---|---|
| | units | parts | parts | parts |
| VORANOL 3008 | | 100 | | |
| VORANOL 3322 | | | 100 | |
| Polyol of Step 2 | | | | 100 |
| TEGOSTAB BF-2370 | | 1 | 1 | 1 |
| NIAX A-1 | | 0.05 | 0.05 | 0.05 |
| DABCO 33-LV | | 0.15 | 0.15 | 0.15 |
| Water Total | % | 4.50 | 4.50 | 4.50 |
| DABCO T9 | | 0.18 | 0.18 | 0.18 |

ISOCYANATE:

| | | | | |
|---|---|---|---|---|
| VORANATE T-80 | | 57.5 | 56.1 | 56.9 |
| Index | | 110 | 110 | 110 |
| Blow off/Rise time | sec | 105 | 99 | 116 |
| Blow | | yes | yes | Yes |
| Shrink | | no | no | no |
| Settle | % | 0 | 0 | 0 |

Physical Properties

| | | | | | |
|---|---|---|---|---|---|
| Density | kg/m³ | ISO | 24.4 | 25.0 | 26.0 |
| | | 3386 | | | |
| CFD 40% | kPa | ISO | 3.24 | 3.46 | 4.19 |
| | | 3386 | | | |
| SAG | | ISO | 1.46 | 1.41 | 1.49 |
| | | 3386 | | | |
| Hysteresis | % | ISO | 60 | 58 | 57 |
| | | 3386 | | | |
| Hysteresis loss | % | ISO | 40 | 42 | 43 |
| | | 3386 | | | |
| Airflow uncrushed | scfm | D3574 | 0.72 | 1.25 | 1.64 |
| Tensile | kPa | ISO | 119 | 109 | 100 |
| | | 1798 | | | |
| Elongation | % | ISO | 172 | 190 | 133 |
| | | 1798 | | | |
| Ball rebound | % | ASTM | 32.8 | 34.5 | 34.0 |
| | | D3574 | | | |
| Ball rebound | % | Toyota | 37.8 | 37.0 | 34.0 |
| | | TS | | | |
| | | M7100 | | | |
| CS 75% | | ISO | 11.5 | 10.2 | 9.8 |
| | | 1856 | | | |
| CS 90% | | ISO | 9.4 | 9.4 | 10.2 |
| | | 1856 | | | |

While the foregoing is directed to embodiments of the present invention, other and further embodiments of the invention may be devised without departing from the basic scope thereof, and the scope thereof is determined by the claims that follow.

1. A method of preparing a polyurethane foam, the method comprising:
reacting least one initiator comprising at least two hydroxyl groups with at least one 12-hydroxystearic acid per equivalent hydroxyl of the initiator to form at least one polyester polyol;
reacting the at least one polyester polyol with at least one alkoxylating agent in the presence of a DMC catalyst to form at least one polyether/polyester polyol; and
reacting the at least one polyether/polyester polyol with at least one isocyanate.

2. A polyurethane foam comprising the reaction product of a reaction system comprising:
at least one isocyanate; and
at least one polyether/polyester polyol, wherein the polyether/polyester polyol comprises at least one polyester polyol that has been alkoxylated by an alkoxylating agent in the presence of a DMC catalyst to form the at least one polyether/polyester polyol polyol, and wherein the at least one polyester polyol comprises the reaction product of at least at least one initiator comprising at least 2 hydroxyl groups and at least one 12-hydroxystearic acid per equivalent hydroxyl of the initiator.

3. The method of claim 1 wherein the polyurethane foam comprises a flexible foam, the hydroxyl functionality of the initiator is from about 2 to about 4, the molecular weight of the initiator is from about 50 to about 180, from about 1 to about 2 moles of hydroxystearic acid per equivalent hydroxyl of the initiator is reacted with the initiator, and the polyether/polyester polyol has a number average molecular weight of between about 2500 and about 3500.

4. The method of claim 1 wherein the polyurethane foam comprises a high resilience flexible foam having a resiliency of at least about 40 percent, the hydroxyl functionality of the initiator is from about 3 to about 6, the molecular weight of the initiator is from about 50 to about 180, from about 1 to about 2 moles of hydroxystearic acid per equivalent hydroxyl of the initiator is reacted with the initiator, and the polyether/polyester polyol has a number average molecular weight of between about 3000 and about 8000.

5. The method of claim 1 wherein the polyurethane foam comprises a viscoelastic flexible foam having a resiliency of less than about 25 percent, the hydroxyl functionality of the initiator is from about 2 to about 4, the molecular weight of the initiator is from about 50 to about 180, from about 1 to about 4 moles of hydroxystearic acid per equivalent hydroxyl of the initiator is reacted with the initiator, and the polyether/polyester polyol has a number average molecular weight of between about 1800 and about 3000.

6. The method of claim 1 wherein the polyurethane foam comprises a rigid foam, the hydroxyl functionality of the initiator is from about 3 to about 8, the molecular weight of the initiator is from about 50 to about 180, from about 1 to about 4 moles of hydroxystearic acid per equivalent hydroxyl of the initiator is reacted with the initiator, and the polyether/polyester polyol has a number average molecular weight of between about 1000 and about 4000.

7. The method of claim 1 wherein the polyurethane foam comprises at least one of coating, adhesive, or sealant, the hydroxyl functionality of the initiator is from about 2 to about 4, the molecular weight of the initiator is from about 50 to about 250, from about 1 to about 2 moles of hydroxystearic acid per equivalent hydroxyl of the initiator is reacted with the initiator, and the polyether/polyester polyol has a number average molecular weight of between about 3000 and about 8000.

8. The method of claim 1 wherein the polyurethane foam comprises a Reaction Injection Molding polyurethane, the hydroxyl functionality of the initiator is from about 2 to about 4, the molecular weight of the initiator is from about 50 to about 180, from about 1 to about 2 moles of hydroxystearic acid per equivalent hydroxyl of the initiator is reacted with the initiator, and the polyether/polyester polyol has a number average molecular weight of between about 3000 and about 8000.

9. The method of claim 1 wherein the initiator comprises at least one of neopentylglycol, 1,2-propylene glycol, trimethylolpropane, pentaerythritol, sorbitol, sucrose, glycerol, ethanolamine, diethanolamine, and triethanolamine, 1,6-hexanediol, 1,4-butanediol, 1,4-cyclohexane diol, 2,5-hexanediol, ethylene glycol, diethylene glycol, triethylene glycol, bis-3-aminopropyl methylamine, ethylene diamine, diethylene triamine, 9(1)-hydroxymethyloctadecanol, 1,4-bishydroxymethylcyclohexane, 8,8-bis(hydroxymethyl)tricyclo[5,2,1,02,6]decene, hydrogenated bisphenol, 9,9(10,10)-bishydroxymethyloctadecanol, and 1,2,6-hexanetriol.

10. The method of claim 1 wherein the at least one polyester polyol is alkoxylated by an alkoxylating agent which is first propylene oxide followed by a mixture of ethylene oxide and propylene oxide.

11. The method of claim 1 wherein the at least one polyether/polyester polyol comprises 100% of the polyols used.

12. (canceled)

13. The polyurethane foam of claim 2 wherein the polyurethane foam comprises a flexible foam, the hydroxyl functionality of the initiator is from about 2 to about 4, the molecular weight of the initiator is from about 50 to about 180, from about 1 to about 2 moles of hydroxystearic acid per equivalent hydroxyl of the initiator is reacted with the initiator, and the polyether/polyester polyol has a number average molecular weight of between about 2500 and about 3500.

14. The polyurethane foam of claim 2 wherein the polyurethane foam comprises a high resilience flexible foam having a resiliency of at least about 40 percent, the hydroxyl functionality of the initiator is from about 3 to about 6, the molecular weight of the initiator is from about 50 to about 180, from about 1 to about 2 moles of hydroxystearic acid per equivalent hydroxyl of the initiator is reacted with the initiator, and the polyether/polyester polyol has a number average molecular weight of between about 3000 and about 8000.

15. The polyurethane foam of claim 2 wherein the polyurethane foam comprises a viscoelastic flexible foam having a resiliency of less than about 25 percent, the hydroxyl functionality of the initiator is from about 2 to about 4, the molecular weight of the initiator is from about 50 to about 180, from about 1 to about 4 moles of hydroxystearic acid per equivalent hydroxyl of the initiator is reacted with the initiator, and the polyether/polyester polyol has a number average molecular weight of between about 1800 and about 3000.

16. The polyurethane foam of claim 2 wherein the polyurethane foam comprises a rigid foam, the hydroxyl functionality of the initiator is from about 3 to about 8, the molecular weight of the initiator is from about 50 to about 180, from about 1 to about 4 moles of hydroxystearic acid per equivalent hydroxyl of the initiator is reacted with the initiator, and the polyether/polyester polyol has a number average molecular weight of between about 1000 and about 4000.

17. The polyurethane foam of claim 2 wherein the polyurethane foam comprises at least one of coating, adhesive, or sealant, the hydroxyl functionality of the initiator is from about 2 to about 4, the molecular weight of the initiator is from about 50 to about 250, from about 1 to about 2 moles of hydroxystearic acid per equivalent hydroxyl of the initiator is reacted with the initiator, and the polyether/polyester polyol has a number average molecular weight of between about 3000 and about 8000.

18. The polyurethane foam of claim 2 wherein the polyurethane foam comprises a Reaction Injection Molding polyurethane, the hydroxyl functionality of the initiator is from about 2 to about 4, the molecular weight of the initiator is from about 50 to about 180, from about 1 to about 2 moles of hydroxystearic acid per equivalent hydroxyl of the initiator is reacted with the initiator, and the polyether/polyester polyol has a number average molecular weight of between about 3000 and about 8000.

19. The polyurethane foam of claim 2 wherein the initiator comprises at least one of neopentylglycol, 1,2-propylene glycol, trimethylolpropane, pentaerythritol, sorbitol, sucrose, glycerol, ethanolamine, diethanolamine, and triethanolamine, 1,6-hexanediol, 1,4-butanediol, 1,4-cyclohexane diol, 2,5-hexanediol, ethylene glycol, diethylene glycol, triethylene glycol, bis-3-aminopropyl methylamine, ethylene diamine, diethylene triamine, 9(1)-hydroxymethyloctadecanol, 1,4-bishydroxymethylcyclohexane, 8,8-bis(hydroxymethyl)tricyclo[5,2,1,02,6]decene, hydrogenated bisphenol, 9,9(10,10)-bishydroxymethyloctadecanol, and 1,2,6-hexanetriol.

20. The polyurethane foam of claim 2 wherein the at least one polyester polyol is alkoxylated by an alkoxylating agent which is first propylene oxide followed by a mixture of ethylene oxide and propylene oxide.

21. The polyurethane foam of claim 2 wherein the at least one polyether/polyester polyol comprises 100% of the polyols used.
